(19) United States
(12) Patent Application Publication
(10) Pub. No.: US 2009/0013082 A1
(43) Pub. Date: Jan. 8, 2009

(54) Field communication system, field server, field device, and field communication method

(75) Inventor: Hiroshi Nara, Tokyo (JP)

Correspondence Address: EDWARDS ANGELL PALMER & DODGE LLP, P.O. BOX 55874, BOSTON, MA, 02205, US

(73) Assignee: Yokogawa Electric Corporation, Tokyo (JP)

(21) Appl. No.: 11/903,572

(22) Filed: Sep. 24, 2007

(30) Foreign Application Priority Data
Sep. 25, 2006 (JP) 2006-258372

(51) Int. Cl. G06F 15/16

(52) U.S. Cl. 709/228

(57) ABSTRACT

A transmitting section spontaneously transmits a command including device information relating to a field device, to a field server. An updating section receives commands including device information which is spontaneously transmitted from field devices, and updates a database on the basis of the device information. Based on the device information stored in the database, a server communicating section communicates with the field devices.

This application claims priority to Japanese Patent Application No. 2006-258372, filed Sep. 25, 2006, in the Japanese Patent Office. The priority application is incorporated by reference in its entirety.

### TECHNICAL FIELD

The present disclosure relates to a field communication system which executes communication between a field server and a field device, and the like.

### RELATED ART

FIG. 2 is a block diagram showing a configuration example of a related-art plant control system. As shown in FIG. 2, the plant control system includes: OPC (OLE for Process Control) servers 103 which are distributedly arranged in a plant, and which control field devices 101A, 101B, 101C, . . . ; and terminal devices 105A, 105B, 105C, . . . which are connected to the OPC servers 103 through a communication bus 104.

In the case where such a system is constructed, in addition to information relating to the network configuration such as types of connected field devices, and communication addresses, device information related to the connected field devices, such as detail information of data possessed by the field devices must be set in the OPC server 103.

When this setting is done, the terminal devices 105A, 105B, 105C, . . . can operate as OPC clients, and can access the OPC server 103 by using the OPC communication protocol. Therefore, the terminal devices 105A, 105B, 105C, . . . can monitor data of the field devices or set parameters without being conscious of the physical configurations of the field devices.

For example, Japanese Patent Unexamined Publication No. 2005-141524 discloses the configurations of an OPC client, an OPC server, and a field device.

When a field device is added, changed, or removed, however, the OPC server 103 cannot automatically know it. Therefore, the server administrator must perform the work of setting it. Usually, the person who operates a field device is different from the server administrator, and hence the setting work requires a prolonged time period and becomes troublesome.

Generally, the OPC communication protocol cannot advance beyond a firewall, and hence a field device cannot be monitored via the Internet. An OPC client is not necessary to be conscious of the physical connections among the OPC server and field devices, etc. According to the standard, however, an OPC client must be always conscious of information of devices stored in the OPC server, and their data structures.

### SUMMARY

Exemplary embodiments of the present invention provide a field communication system, and the like in which an adequate communication state can be ensured without requiring an engineering work.

A field communication system according to one or more embodiments of the present invention executes communication between a field server and a field device, wherein the system comprises: a transmitting section for spontaneously transmitting information relating to the field device, from the field device to the field server; an updating section for, based on the information transmitted by the transmitting section, updating a database of the field server; and a server communicating section for, based on the database, executing communication between the field server and the field device.

According to the field communication system, information relating to a field device is spontaneously transmitted from the field device to the field server, and the database of the field server is updated on the basis of the transmitted information. Therefore, communication between the field server and the field device is enabled without requiring an engineering work.

The field communication system may be configured so that the system further comprises a model storing section for causing a model to be stored in the field server, the model indicating a data structure corresponding to a type of a field device, and the information transmitted by the transmitting section is stored with being correlated to the corresponding model.

The field communication system may be configured so that the field server functions as an OPC server and an http server.

A field server according to one or more embodiments of the present invention executes communication with a field device, wherein the field server comprises: an updating section for receiving information relating to the field device, the information being spontaneously transmitted from the field device, and for updating a database based on the information; and a server communicating section for, based on the database, communicating with the field device.

The field server may be configured so that the field server further comprises a model storing section for storing a model indicating a data structure corresponding to a type of a field device, and the information is stored in the database with being correlated to the corresponding model.

A field device according to one or more embodiments of the present invention executes communication with a field server, wherein the field device comprises: a transmitting section for spontaneously transmitting information relating to the field device to the field server; and an device communicating section for executing communication according to the information, with the field server.

A field communication method according to one or more embodiments of the present invention executes communication between a field server and a field device, wherein the method comprises the steps: spontaneously transmitting information relating to the field device, from the field device to the field server; updating a database of the field server based on the information transmitted by the transmitting step; and executing communication between the field server and the field device based on the database.

According to the field communication system according to one or more embodiments of the present invention, information relating to a field device is spontaneously transmitted from the field device to the field server, and the database of the field server is updated on the basis of the transmitted information. Therefore, communication between the field server and the field device is enabled without requiring an engineering work.

Other features and advantages may be apparent from the following detailed description, the accompanying drawings and the claims.

### BRIEF DESCRIPTION OF THE DRAWINGS

FIG. 1 is a block diagram showing the configuration of a plant control system to which a field communication system of an embodiment is applied.

FIG. 2 is a block diagram showing a configuration example of a related-art plant control system.

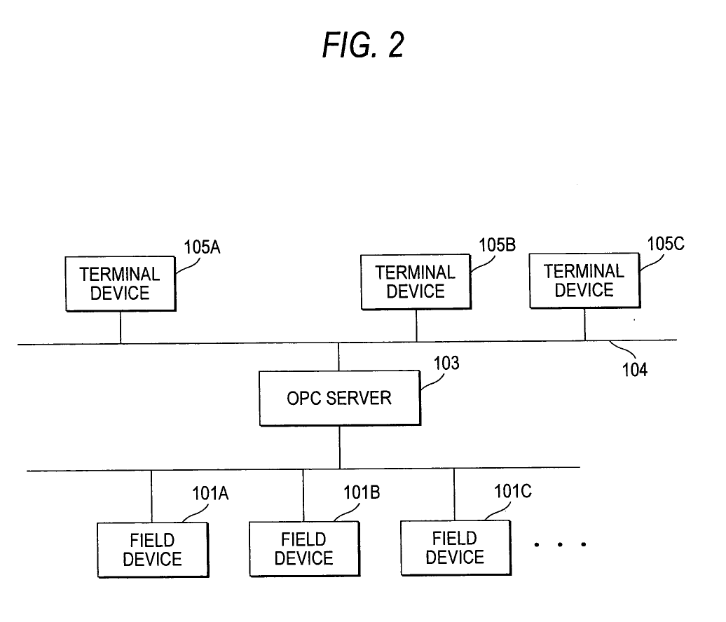

### DETAILED DESCRIPTION

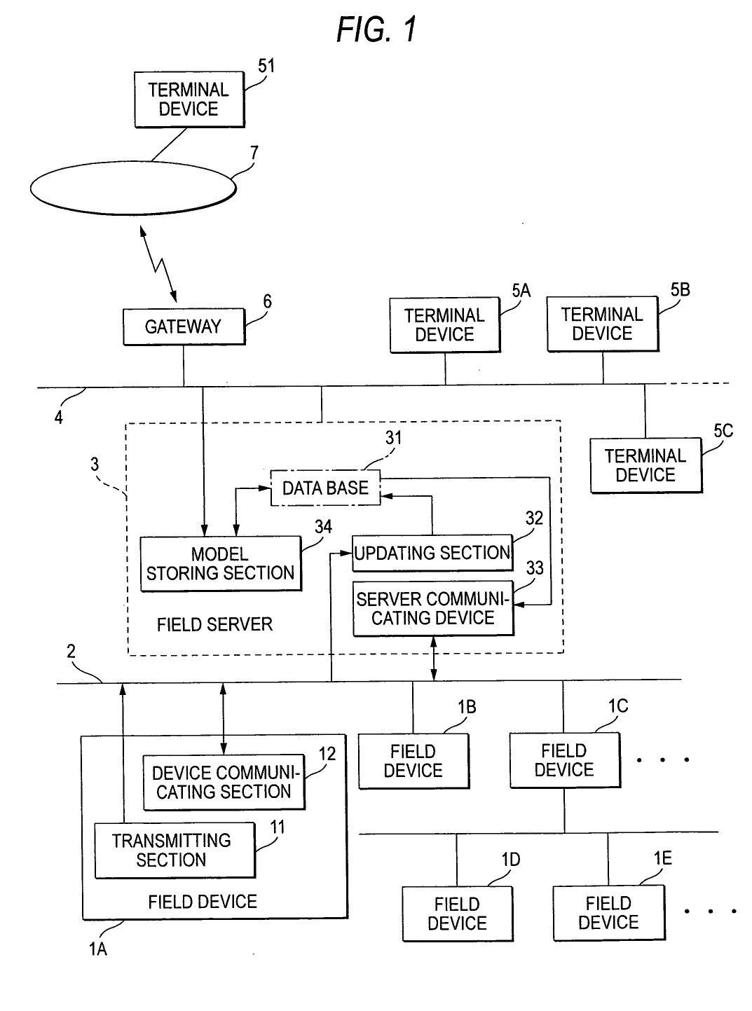

Hereinafter, an embodiment of the field communication system of the present invention will be described with reference to FIG. 1.

FIG. 1 is a block diagram showing the configuration of a plant control system to which the field communication system of the embodiment is applied. As shown in FIG. 1, the plant control system comprises: a field server 3 which is connected to field devices 1A, 1B, 1C, 1D, . . . through a control bus 2; and terminal devices 5A, 5B, 5C, . . . which are connected to the field server 3 through an information bus 4.

The field devices 1A, 1B, 1C, 1D, . . . and the field server 3 have a function of communicating with one another through the control bus 2.

As shown in FIG. 1, the field device 1A configures: a transmitting section 11 for spontaneously transmitting a command including device information relating to the field device 1A, to the field server 3; and an device communicating section 12 for performing communication with the field server 3 according to the device information.

In the same manner as the field device 1A, also the other field devices 1B, 1C, 1D, . . . configure the transmitting section 11 and the device communicating section 12 (not shown).

The field device 1C has a gateway function, and transmits a command of the device itself, and also commands transmitted from the field devices 1D, 1E. Because of the gateway function of the field device 1C, the field server 3 can treat the field devices 1D, 1E in the same manner as the other field devices which are directly connected to the control bus 2.

The transmitting section 11 spontaneously broadcast transmits the command without receiving a request from the field server 3, and the like. When the field devices 1A, 1B, 1C, 1D, . . . are powered on, for example, the devices periodically output the command irrespective of whether connected to the control bus 2 or not, or of the connection state. For example, the device information of the command includes information of the type names of the field devices 1A, 1B, 1C, 1D, . . . , input ranges, output ranges, control types (control algorithms such as PID), serial numbers, etc.

As shown in FIG. 1, the field server 3 configures: a database 31 which stores the device information relating to the field devices 1A, 1B, 1C, 1D, . . . ; an updating section 32 for receiving commands including the device information which is spontaneously transmitted from the field devices 1A, 1B, 1C, 1D, . . . , and for updating the database 31 on the basis of the device information; a server communicating section 33 for, based on the device information stored in the database 31, communicating with the field devices; and a model storing section 34 for storing a model indicating a data structure corresponding to a type of a field device.

The field server 3 functions as an OPC server, and also as an http server. In addition to OPC clients (for example, the terminal device 5A), therefore, also http clients (for example, the terminal device 5B) on which a general www browser is installed can access the field server 3. Furthermore, http does not depend on the OS, and hence the OS of a client is not restricted. When a gateway 6 is connected to the information bus 4, http clients (for example, a terminal device 51) on which a general www browser is installed can access the field server 3 via the Internet 7.

Next, the operation of the field communication system of the embodiment will be described.

When the field device 1A is connected to the control bus 2, the command which is output from the transmitting section 11 of the field device 1A is transmitted through the control bus 2, and received by the updating section 32 of the field server 3. Upon the reception of the command, the field server 3 automatically knows the connection and communication address of the field device 1A. The updating section 32 writes the device information included in the received command, into the database 31, thereby updating the database 31.

On the other hand, the model storing section 34 stores models which indicate data structures of device information of respective field devices, with being correlated to the type names of the devices. As described above, device information stored in the database includes information of the type name. Therefore, the data structure of device information stored in the database is known by a model which is stored in the model storing section 34 with being provided with the type name.

In this way, in the field server 3, device information of the field devices 1A, 1B, 1C, 1D, . . . is automatically stored together with its data structure, and meanings of all data constituting device information are completely known. Therefore, an engineering work of enabling communication is not required. In the field server 3 and the field devices, the server communicating section 33 and the device communicating section 12 execute communication through the control bus 2 based on the latest device information stored in the database 31. This communication includes transmission and reception of a process value and a preset value. In the field communication system of the embodiment, even when the plant facility is changed, or for example a field device is added, changed, or removed, the database 31 is automatically updated simply by connecting the field device. Therefore, communication between the field server 3 and the field device is enabled without requiring an engineering work.

In the field server 3, meanings of all data constituting device information are completely known. When an operation such as monitoring of data of the field devices 1A, 1B, 1C, 1D, . . . via the general www browser, or setting of parameters is performed, therefore, a client is not required to be conscious of the data structure of the device information, and the like, other than designation of a field device. When process values of the field devices 1A, 1B, 1C, 1D, . . . are displayed on a client, or a screen for setting parameters is displayed, for example, an adequate display form can be obtained on the basis of device information.

As described above, the model storing section 34 stores models which indicate data structures of device information, with being correlated to the type names of the field devices. In the field communication system of the embodiment, in accordance with field devices to be used, a new model can be additionally stored in the model storing section 34. In the case where a new field device is introduced in the plant, for example, a model corresponding to the device (type name) can be added. For example, the model is provided by the manufacturer of the device, or a developer of the plant control system. When a new field device is developed, a new model indicating a new data structure of device information may be prepared.

As described above, according to the field communication system of the present invention, information relating to a field device is spontaneously transmitted from the field device to the field server, and the database of the field server is updated on the basis of the transmitted information. Therefore, communication between the field server and the field device is enabled without requiring an engineering work. Addition of a model can flexibly cope with the use of a new field device.

The application range of the present invention is not restricted to the embodiment. The invention can be widely applied to cases where communication is executed between a field server and a field device.

While the present invention has been described with respect to a limited number of embodiments, those skilled in the art, having benefit of this disclosure, will appreciate that other embodiments can be devised which do not depart from the scope of the present invention as disclosed herein. Accordingly, the scope of the present invention should be limited only by the attached claims.

What is claimed is:

1. A field communication system which executes communication between a field server and a field device, said system comprising:
a transmitting section for spontaneously transmitting information relating to said field device, from said field device to said field server;
an updating section for, based on the information transmitted by said transmitting section, updating a database of said field server; and
a server communicating section for, based on said database, executing communication between said field server and said field device.

2. A field communication system according to claim 1, further comprising:
a model storing section for causing a model to be stored in said field server, the model indicating a data structure corresponding to a type of a field device,
wherein the information transmitted by said transmitting section is stored with being correlated to the corresponding model.

3. A field communication system according to claim 1, wherein said field server functions as an OPC server and an http server.

4. A field communication system according to claim 2, wherein said field server functions as an OPC server and an http server.

5. A field server which executes communication with a field device, said field server comprising:
an updating section for receiving information relating to said field device, the information being spontaneously transmitted from said field device, and for updating a database based on the information; and
a server communicating section for, based on said database, communicating with said field device.

6. A field server according to claim 5, further comprising:
a model storing section for storing a model indicating a data structure corresponding to a type of a field device,
wherein the information is stored in said database with being correlated to the corresponding model.

7. A field device which executes communication with a field server, said field device comprising:
a transmitting section for spontaneously transmitting information relating to said field device to said field server; and
an device communicating section for executing communication according to the information, with said field server.

8. A field communication method which executes communication between a field server and a field device, said method comprising the steps:
spontaneously transmitting information relating to said field device, from said field device to said field server;
updating a database of said field server based on the information transmitted by said transmitting step; and
executing communication between said field server and said field device based on said database.
